(19) United States
(12) Patent Application Publication
(10) Pub. No.: US 2014/0321528 A1
(43) Pub. Date: Oct. 30, 2014

(54) VIDEO ENCODING AND/OR DECODING METHOD AND VIDEO ENCODING AND/OR DECODING APPARATUS

(71) Applicant: INTELLECTUAL DISCOVERY CO., LTD., Seoul (KR)

(72) Inventors: Tae Young JUNG, Seoul (KR); Dong Jin PARK, Namyangju-si (KR)

(73) Assignee: INTELLECTUAL DISCOVERY CO., LTD., Seoul (KR)

(21) Appl. No.: 14/265,049

(22) Filed: Apr. 29, 2014

(30) Foreign Application Priority Data
Apr. 30, 2013 (KR) 10-2013-0048145

(51) Int. Cl. H04N 19/436; H04N 19/105; H04N 19/172; H04N 19/43; H04N 19/196

(52) U.S. Cl. CPC H04N 19/00521; H04N 19/00509; H04N 19/00375; H04N 19/00266; H04N 19/00024
USPC 375/240.02

(57) ABSTRACT

The present invention relates to a method and apparatus for processing a video, wherein the apparatus includes a controller to parse a parameter set from an input bitstream and a plurality of video processing units to process video data by a frame unit in parallel based on the parsed parameter set according to control by the controller, wherein the video processing units sequentially decode different frames at an interval determined based on a motion vector range in the parameter set.

### CROSS-REFERENCE TO RELATED APPLICATION

This application claims the benefit of priority of Korean Patent Application No. 10-2013-0048145 filed on Apr. 30, 2013, which is incorporated by reference in its entirety herein.

### TECHNICAL FIELD

The present invention relates to a video encoding and/or decoding method and a video encoding and/or decoding apparatus, and more particularly to a method and an apparatus for scalably processing a video using a plurality of processing units.

### BACKGROUND ART

With need for ultra high definition (UHD), existing video compression techniques have difficulty in accommodating sizes of storage media and bandwidths of transfer media. Accordingly a novel standard for compression of UHD videos is needed. High Efficiency Video Coding (HEVC) is available for a video stream serviced through the Internet, 3G and LTE networks, in which not only UHD but also full high definition (FHD) or high definition (HD) videos can be compressed in accordance with HEVC.

A UHD TV is considered to mainly provide 4K UHD at 30 frames per second (fps) in the short term, while the number of pixels to be processed per second is expected to increase to 4K 60 fps/120 fps, 8K 30 fps/60 fps, etc.

To cost-effectively deal with different resolutions and frame rates in such applications, a video encoding apparatus which is easily extensible based on performance and functions required for applications is needed.

### DISCLOSURE

### Technical Problem

The present invention is contrived to solve the aforementioned issues, and an aspect of the present invention is to provide a video encoding and/or decoding method and a video encoding and/or decoding apparatus based on parallel processing which are capable of efficiently processing high-resolution video data.

### Technical Solution

An embodiment of the present invention provides a video encoding and/or decoding apparatus including a controller to parse a parameter set from an input bitstream, and a plurality of video processing units to process video data by a frame unit in parallel based on the parsed parameter set according to control by the controller, wherein the video processing units sequentially decode different frames at an interval determined based on a motion vector range in the parameter set.

Another embodiment of the present invention provides a video encoding and/or decoding method including parsing a parameter set from an input bitstream, and processing video data by a frame unit in parallel based on the parsed parameter set using a plurality of video processing units, wherein the processing in parallel starts sequentially decoding different frames at an interval based on a motion vector range in the parameter set.

Meanwhile, the video processing method may be implemented by a computer-readable recording medium recoding a program to be executed in a computer.

### Advantageous Effects

As described above, the present invention provides a decoder capable of effectively processing pixels as the number of pixels to be processed per second increases to 4K 60 fps/120 fps, 8K 30 fps/60 fps, etc. as in a UHD TV.

### DESCRIPTION OF DRAWINGS

FIG. 1 is a block diagram illustrating a configuration of an encoding apparatus according to an exemplary embodiment of the present invention.

FIG. 2 is a block diagram illustrating a configuration of a decoding apparatus according to an exemplary embodiment of the present invention.

FIG. 3 illustrates a frame-based parallel processing method according to an exemplary embodiment.

FIG. 4 illustrates a configuration of a video processing apparatus according to an exemplary embodiment of the present invention.

FIG. 5 illustrates an MbY synchronizing method according to an exemplary embodiment.

FIG. 6 illustrates that a controller performs synchronization according to information signaled from a host according to an exemplary embodiment.

FIG. 7 illustrates the MbY synchronizing method in detail.

FIG. 8 illustrates a method of processing a video when a plurality of VPUs are unable to share a DPB according to an exemplary embodiment.

FIG. 9 illustrates a DPB synchronizing method according to an exemplary embodiment.

FIG. 10 illustrates a method of processing a stream end of a video stream according to an exemplary embodiment.

FIGS. 11 and 12 illustrate occurrence of errors in frame-based parallel processing.

### MODE FOR INVENTION

Hereinafter, exemplary embodiments of the present invention will be described in detail with reference to the accompanying drawings so that this disclosure will fully convey the scope of the invention to those having ordinary knowledge in the art to which the present invention pertains. This invention may, however, be embodied in many different forms and should not be construed as limited to the exemplary embodiments set forth herein. Configurations or elements unrelated to the description are omitted in the drawings as to clarify the present invention, and like reference numerals refer to like elements throughout.

It will be understood that when an element is referred to as being “connected to” another element, the element can be not only directly connected to another element but also electrically connected to another element via an intervening element.

It will be further understood that when a member is referred to as being “on” another member, the member can be directly on another member or an intervening member.

Unless specified otherwise, the terms “comprise,” “include,” “comprising,” and/or “including” specify the presence of elements and/or components, but do not preclude the presence or addition of one or more other elements and/or components. The terms “about” and “substantially” used in this specification to indicate degree are used to express a numerical value or an approximate numerical value when a mentioned meaning has a manufacturing or material tolerance and are used to prevent those who are dishonest and immoral from wrongfully using the disclosure of an accurate or absolute numerical value made to help understanding of the present invention. The term “stage (of doing)” of “stage of” used in this specification to indicate degree does not mean “stage for.”

It will be noted that the expression “combination thereof” in a Markush statement means a mixture or combination of one or more selected from the group consisting of elements mentioned in the Markush statement, being construed as including one or more selected from the group consisting of the elements.

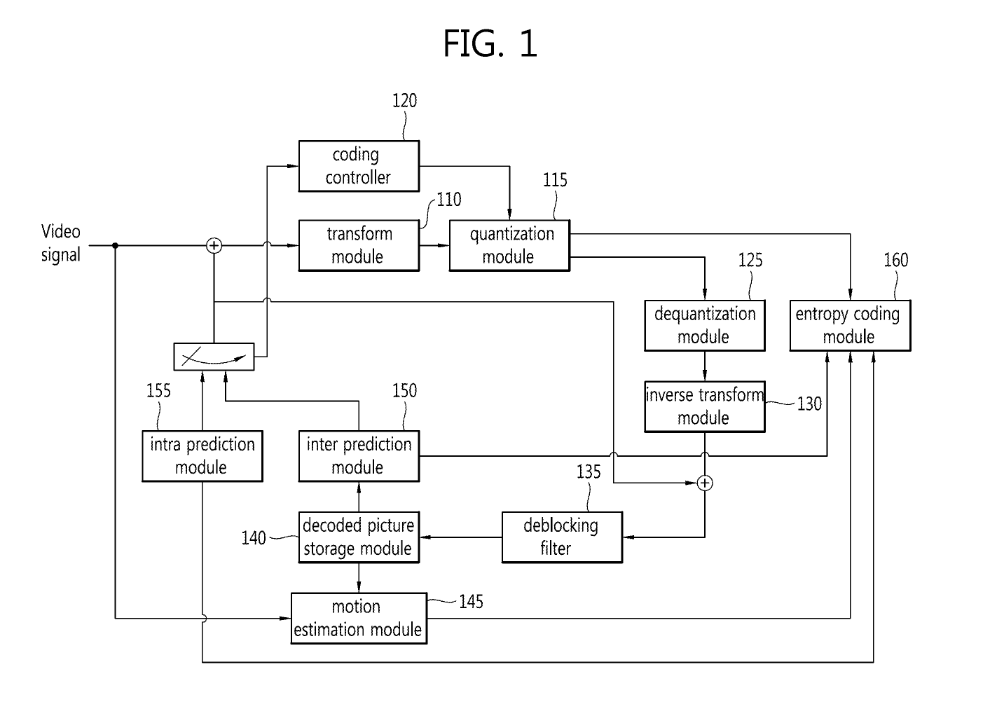

FIG. 1 is a block diagram illustrating a configuration of an encoding apparatus according to an exemplary embodiment of the present invention. The encoding apparatus 100 includes a transform module 110, a quantization module 115, a coding controller 120, a dequantization module 125, an inverse transform module 130, a deblocking filter 135, a decoded picture storage module 140, a motion estimation module 145, an inter prediction module 150, an intra prediction module 155 and an entropy coding module 170.

Referring to FIG. 1, the transform module 110 transforms a pixel value to obtain a transform coefficient, in which discrete cosine transform (DCT) or wavelet transform may be used.

The quantization module 115 quantizes the transform coefficient output from the transform module 110. The coding controller 120 controls whether to perform intra coding or inter coding on a block or frame. The dequantization module 125 dequantizes the transform coefficient, and the inverse transform module 130 reconstructs the dequantized transform coefficient into the original pixel value.

For example, DCT or wavelet transform may be used. Particularly, in DCT, an input video signal is divided into blocks of a certain size and transformed. Coding efficiency may change depending on distribution and characteristics of values in a transform domain in transformation.

The deblocking filter 135 is applied to each coded macroblock so as to decrease block distortion, and a picture having subjected to deblocking filtering is stored in the decoded picture storage module 140 to be used as a reference picture.

The motion estimation module 145 searches a reference block most similar to a current block among reference pictures stored in the decoded picture storage module 140 and transmits location information on the searched reference block to the entropy coding module 160.

The inter prediction module 150 predicts a current picture using a reference picture and transmits inter coding information to the entropy coding module 160. The intra prediction module 155 performs intra prediction from a decoded pixel in the current picture and transmits intra coding information to the entropy coding module 160.

The entropy coding module 160 entropy-codes the quantized transform coefficient, the inter coding information, the intra coding information and information on the reference block input from the motion estimation module 145 to generate a video bitstream at a random time.

For example, the entropy coding module 160 may use variable length coding (VLC) and arithmetic coding.

VLC transforms input symbols into consecutive codewords, which may have variable lengths. For instance, frequently appearing symbols are represented as short codewords, while less frequently appearing symbols are represented as long codewords.

Context-based adaptive variable coding (CAVLC) may be used as VLC. Arithmetic coding transforms consecutive data symbols into a single decimal and may obtain optimal decimal bit necessary for representing each symbol. Context-based adaptive binary arithmetic coding (CABAC) may be used as arithmetic coding.

Generally, the encoding apparatus includes an encoding process and a decoding process, while a decoding apparatus includes a decoding process. The decoding process of the decoding apparatus may be the same as the decoding process of the encoding apparatus and be configured by performing the operations of the encoding apparatus illustrated in FIG. 1 in reverse order.

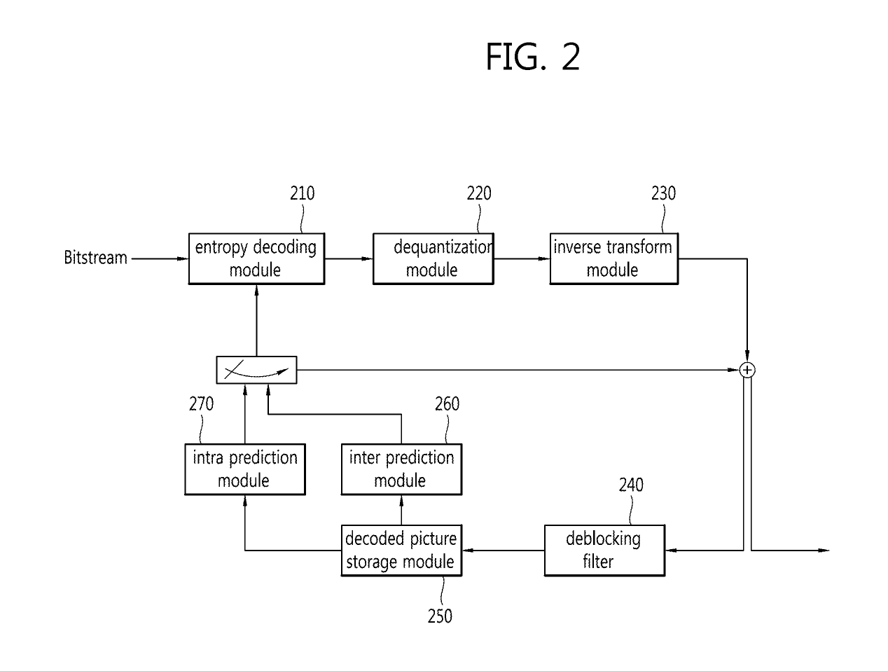

FIG. 2 is a block diagram illustrating a configuration of a decoding apparatus according to an exemplary embodiment of the present invention. The decoding apparatus 200 includes an entropy decoding module 210, a dequantization module 220, an inverse transform module 230, a deblocking filter 240, a decoded picture storage module 250, an inter prediction module 260 and an intra prediction module 270.

Referring to FIG. 2, the entropy decoding module 210 entropy-decodes a video signal bitstream to extract a transform coefficient, a motion vector and the like of each macroblock. The dequantization module 220 dequantizes the entropy-decoded transform coefficient, and the inverse transform module 230 reconstructs an original pixel value from the dequantized transform coefficient.

The deblocking filter 240 is applied to each coded macroblock so as to decrease block distortion. And a picture having subjected to deblocking filtering is stored in the decoded picture storage module 250 to be used as a reference picture or output.

For example, a filtering module performs filtering on a video to improve video quality. Here, a deblocking filter for decreasing block distortion and/or an adaptive loop filter for removing distortion of an entire video may be included.

The inter prediction module 260 predicts a current picture using a reference picture stored in the decoded picture storage unit 250 and inter prediction information including reference picture index information, motion vector information or the like transmitted from the entropy decoding module 210.

The intra prediction module 270 performs intra prediction from a decoded pixel in the current picture. The current picture predicted by the inter prediction module or intra prediction module is merged with a residual obtained by the inverse transform module 230, thereby reconstructing an original picture.

In one exemplary embodiment of the present invention, a video bitstream is a unit of storing encoded data of one picture and may include a parameter set (PS) and slice data.

A PS is divided into a picture parameter set (PPS) as data corresponding to a head of each picture and a sequent parameter set (SPS). The PPS and SPS may include initialization information needed to initialize each coding.

An SPS may include common reference information for decoding all pictures encoded into a random access unit (RAU), such as a profile, a maximum number of pictures available for reference and a picture size.

A PPS which is reference information for decoding each picture encoded into an RAU may include such as a VLC type, an initial value of quantization and a plurality of reference pictures.

Meanwhile, a slice header (SH) may include information on a slice in coding based on a slice unit.

Tables 1 and 2 illustrate a configuration of an SPS according to an exemplary embodiment.

TABLE 1

| Seq_parameter_set_data( ) { | C | Descriptor |
|---|---|---|
| profile_idc | 0 | u(8) |
| constraint_set0_flag | 0 | u(1) |
| constraint_set1_flag | 0 | u(1) |
| constraint_set2_flag | 0 | u(1) |
| constraint_set3_flag | 0 | u(1) |
| constraint_set4_flag | 0 | u(1) |
| constraint_set5_flag | 0 | u(1) |
| reserved_zero_2bits /* equal to 0 */ | 0 | u(2) |
| level_idc | 0 | u(8) |
| seq_parameter_set_id | 0 | ue(v) |
| if( profile_idc = = 100 \|\| profile_idc = = 110 \|\| | | |
| profile_idc = = 122 \|\| profile_idc = = 244 \|\| | | |
| profile_idc = = 44 \|\| | | |
| profile_idc = = 83 \|\| profile_idc = = 86 \|\| | | |
| profile_idc = = 118 \|\| | | |
| profile_idc = = 128 ) { | | |
| chroma_format_idc | 0 | ue(v) |
| if( chroma_format_idc = = 3 ) | | |
| separate_colour_plane_flag | 0 | u(1) |
| bit_depth_luma_minus8 | 0 | ue(v) |
| bit_depth_chroma_minus8 | 0 | ue(v) |
| qpprime_y_zero_transform_bypass_flag | 0 | u(1) |
| seq_scaling_matrix_present_flag | 0 | u(1) |
| if( seq_scaling_matrix_present_flag ) | | |
| for( i = 0; i < ( ( chroma_format_idc != 3 ) | | |
| ? 8 : 12 ); i++ ) { | | |
| seq_scaling_list_present_flag[ i ] | 0 | u(1) |
| if( seq_scaling_list_present_flag[ i ] ) | | |
| if( i < 6 ) | | |
| scaling_list( ScalingList4×4[ i ], 16, | 0 | |
| UseDefaultScaling- | | |
| Matrix4×4Flag[ i ]) | | |
| else | | |
| scaling_list( ScalingList8×8[ i − 6 ], | 0 | |
| 64, UseDefaultScaling- | | |
| Matrix8×8Flag[ i − 6 ] ) | | |
| } | | |
| } | | |

TABLE 2

| | | |
|---|---|---|
| log2_max_frame_num_minus4 | 0 | ue(v) |
| pic_order_cnt_type | 0 | ue(v) |
| if( pic_order_cnt_type = = 0 ) | | |
| log2_max_pic_order_cnt_lsb_minus4 | 0 | ue(v) |
| else if( pic_order_cnt_type = = 1 ) { | | |
| delta_pic_order_always_zero_flag | 0 | u(1) |
| offset_for_non_ref_pic | 0 | se(v) |
| offset_for_top_to_bottom_field | 0 | se(v) |
| num_ref_frames_in_pic_order_cnt_cycle | 0 | ue(v) |
| for( i = 0; | | |
| i < num_ref_frames_in_pic_order_cnt_cycle; i++ ) | | |
| offset_for_ref_frame[ i ] | 0 | se(v) |
| } | | |
| max_num_ref_frames | 0 | ue(v) |
| gaps_in_frame_num_value_allowed_flag | 0 | u(1) |
| pic_width_in_mbs_minus1 | 0 | ue(v) |
| pic_height_in_map_units_minus1 | 0 | ue(v) |
| frame_mbs_only_flag | 0 | u(1) |
| if( !frame_mbs_only_flag ) | | |
| mb_adaptive_frame_field_flag | 0 | u(1) |
| direct_8×8_inference_flag | 0 | u(1) |
| frame_cropping_flag | 0 | u(1) |
| if( frame_cropping_flag ) { | | |
| frame_crop_left_offset | 0 | ue(v) |
| frame_crop_right_offset | 0 | ue(v) |
| frame_crop_top_offset | 0 | ue(v) |
| frame_crop_bottom_offset | 0 | ue(v) |
| } | | |
| vui_parameters_present_flag | 0 | u(1) |
| if( vui_parameters_present_flag ) | | |
| vui_parameters( ) | 0 | |
| } | | |

Referring to Tables 1 and 2, the SPS is header information including information about encoding of an entire sequence such as a profile or level. And a latest SPS transmitted including a head of the sequence, instead of being attached to the head of the sequence, may be used as header information.

In detail, profile_idc included in the SPS represents information on a profile applied to an encoded video sequence, and level_idc represents information on a level applied to the encoded video sequence.

The profile defines a subset allocated to a syntax of video codec standards, and the level refers to a group of constraints on variables defined by a plurality of syntax elements and parameters.

Table 3 illustrates variables defined by the level according to an exemplary embodiment.

TABLE 3

| | | | | | Max | | | |
|---|---|---|---|---|---|---|---|---|
| | | | | Max video | CPB size | | | |
| | | | | bit rate MaxBR | MaxCPB | | | |
| | Max | | Max | (1000 bits/s, | (1000 bits, | Vertical MV | | Max number of |
| | macroblock | Max | decoded | 1200 bits/s, | 1200 bits, | component | | motion vectors |
| | processing | frame | picture | cpbBrVclFactor | cpbBrVclFactor | range | | per two |
| | rate | size | buffer size | bits/s, or | bits, or | MaxVmvR | Min | consecutive |
| Level | MaxMBPS | MaxFS | MaxDpbMbs | cpbBrNalFactor | cpbBrNalFactor | (luma picture | compression | MBs |
| number | (MB/s) | (MBs) | (MBs) | bits/s) | bits) | samples) | ratio MinCR | MaxMvsPer2Mb |
| 1 | 1 485 | 99 | 396 | 64 | 175 | [−64, +63.75] | 2 | — |
| 1b | 1 485 | 99 | 396 | 128 | 350 | [−64, +63.75] | 2 | — |
| 1.1 | 3 000 | 396 | 900 | 192 | 500 | [−128, +127.75] | 2 | — |
| 1.2 | 6 000 | 396 | 2 376 | 384 | 1 000 | [−128, +127.75] | 2 | — |
| 1.3 | 11 880 | 396 | 2 376 | 768 | 2 000 | [−128, +127.75] | 2 | — |
| 2 | 11 880 | 396 | 2 376 | 2 000 | 2 000 | [−128, +127.75] | 2 | — |
| 2.1 | 19 800 | 792 | 4 752 | 4 000 | 4 000 | [−256, +255.75] | 2 | — |
| 2.2 | 20 250 | 1 620 | 8 100 | 4 000 | 4 000 | [−256, +255.75] | 2 | — |
| 3 | 40 500 | 1 620 | 8 100 | 10 000 | 10 000 | [−256, +255.75] | 2 | 32 |
| 3.1 | 108 000 | 3 600 | 18 000 | 14 000 | 14 000 | [−512, +511.75] | 4 | 16 |
| 3.2 | 216 000 | 5 120 | 20 480 | 20 000 | 20 000 | [−512, +511.75] | 4 | 16 |
| 4 | 245 760 | 8 192 | 32 768 | 20 000 | 25 000 | [−512, +511.75] | 4 | 16 |
| 4.1 | 245 760 | 8 192 | 32 768 | 50 000 | 62 500 | [−512, +511.75] | 2 | 16 |
| 4.2 | 522 240 | 8 704 | 34 816 | 50 000 | 62 500 | [−512, +511.75] | 2 | 16 |
| 5 | 589 824 | 22 080 | 110 400 | 135 000 | 135 000 | [−512, +511.75] | 2 | 16 |
| 5.1 | 983 040 | 36 864 | 184 320 | 240 000 | 240 000 | [−512, +511.75] | 2 | 16 |
| 5.2 | 2 073 600 | 36 864 | 184 320 | 240 000 | 240 000 | [−512, +511.75] | 2 | 16 |

Referring to Table 3, the level may define a maximum macroblock processing rate (MaxMBPS), a maximum frame size (MaxFS), a maximum decoded picture buffer size (MaxDpbMbs), a maximum video bit rate (MaxBR), a maximum CPB size (MaxCPB), a vertical MV component range (MaxVmvR), a minimum compression ratio (MinCR) and a maximum number of motion vectors per two consecutive macroblocks (MaxMvsPer2Mb).

According to one exemplary embodiment of the present invention, a video encoding or decoding process may be carried out by a frame unit in a scalable manner using a plurality of processing units according to level information, for example, level_idc, of the SPS obtained by parsing the input bitstream.

For instance, while one of the plurality of processing units is decoding a first frame using the vertical MV range in the standards, another decodes a second frame at the same time.

Specifically, after a first processing unit starts decoding an upper section of the first frame and finishes decoding a section corresponding to a vertical MV range, a second processing unit decodes the second frame as a next frame while the first processing unit is decoding the remaining section.

Such a frame-based multi-core scalable parallel processing method may be easily carried out, thus enabling real-time decoding of a 4K or higher video signal.

For example, a video processing apparatus according to an exemplary embodiment of the present invention includes a controller to parse a parameter set from an input bitstream and a plurality of video processing units to process video data by a frame unit in parallel based on the parsed parameter set according to control by the controller, wherein the processing units start sequentially decoding different frames at an interval based on a motion vector range in the parameter set.

The motion vector range may be defined by level information included in an SPS.

After a time corresponding to the interval since a first video processing unit among the plurality of the video processing units starts decoding a first frame, a second video processing unit starts decoding a second frame.

Subsequently, the first video processing unit starts decoding a third frame after finishing decoding the first frame, and accordingly decoding sections of the first and third frames may partly overlap a decoding section of the second frame of the second video processing unit.

The video processing units may be synchronized with a decoded picture buffer (DPB) to transmit and receive necessary information for managing a reference frame.

A position difference between macroblocks of a current frame and a reference frame may be maintained larger than the motion vector range.

Further, a boundary of a frame not decoded may be retrieved so that two or more video processing units do not decode the same frame.

A video processing method according to an exemplary embodiment of the present invention includes parsing a parameter set from an input bitstream; and processing video data by a frame unit in parallel based on the parsed parameter set using the plurality of video processing units, wherein the processing in parallel may start sequentially decoding different frames at an interval based on a motion vector range in the parameter set.

Hereinafter, a method of processing a video by a frame in a scalable manner using a plurality of video processing units will be described in detail with reference to exemplary embodiments.

Although the following embodiments illustrate that the video processing method and the video processing apparatus process video data by a frame in parallel in decoding, the present invention is not limited thereto. Instead, the present invention may be also applied to when video data is processed by a frame in parallel in encoding.

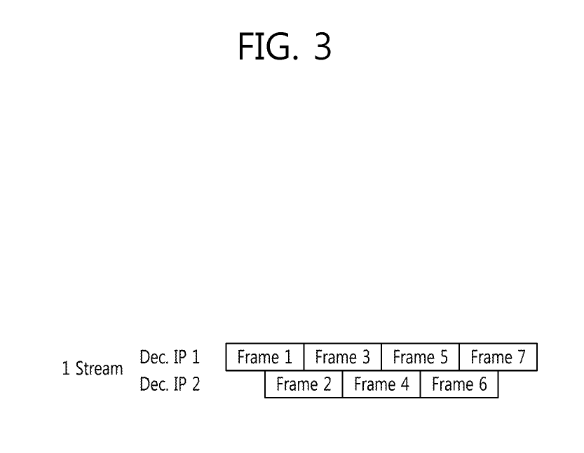

FIG. 3 illustrates a frame-based parallel processing method according to an exemplary embodiment.

Referring to FIG. 3, two video processing units Dec. IP 1 and 2 may separately process a plurality of frames by a frame, thereby decoding a video.

For instance, a first video processing unit may start decoding Frame 1 first, and after a predetermined time, a second video processing unit may start decoding Frame 2. In this case, a decoding section of Frame 1 may partly overlap a decoding section of Frame 2 as shown in FIG. 3.

Subsequently, as shown in FIG. 3, the first video processing unit may sequentially decode Frame 3, Frame 5 and Frame 7 after finishing decoding Frame 1, while the second video processing unit may sequentially decode Frame 4 and Frame 6 after finishing decoding Frame 2.

Meanwhile, in FIG. 3, an interval between times at which the first video processing unit starts decoding Frame 1 and the second video processing unit starts decoding Frame 2 may be determined on a vertical MV range as described above.

Frame-based parallel processing using the plurality of video processing units may reduce time to decode a video, thus making it possible to decode higher-resolution videos in real time.

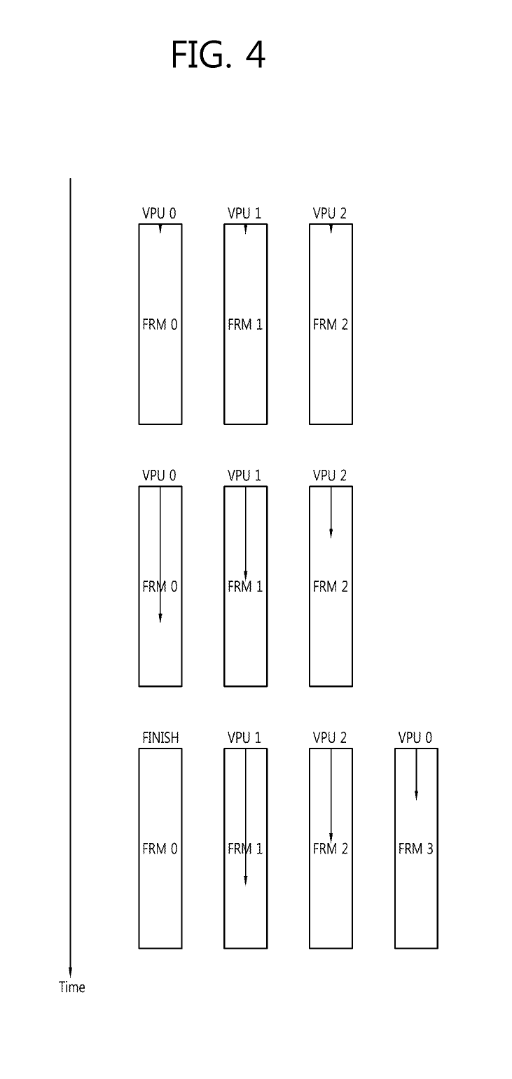

FIG. 4 illustrates a configuration of a video processing apparatus according to an exemplary embodiment of the present invention, in which the video processing apparatus may include a plurality of video processing units (VPUs).

A video processing unit (VPU) is a type of an image processing unit for frame-based parallel processing of a video. The VPUs according to the present embodiment may separately process video data by a frame to decode.

Referring to FIG. 4, with time, while VPU0 starts and continues to decode Frame 0 (FRM0) first, VPU1 subsequently starts and continues to decode Frame 1 (FRM1), during which VUP2 starts and continues to decode Frame 2 (FRM2).

After finishing decoding Frame 0 (FRM0), VPU0 starts to decode Frame 3 (FRM3) while VPU1 and VPU2 are decoding Frame 1 (FRM1) and Frame 2 (FRM2).

Meanwhile, for parallel processing using the plurality of VPUs, a controller to synchronize the VPUs may be needed.

First, synchronization of the VPUs with a decoded picture buffer (DPB) may be needed, through which information necessary for managing reference frames may be shared.

Second, synchronization of macroblocks Y (MbY) may be needed, through which an MbY position difference between a current frame and a reference frame may be maintained always larger than a vertical MV range defined by a level of an SPS.

In this case, a reference pixel of F(j) as a reference for inter prediction of F(i), where j<i, may needed to be available.

Further, information necessary for managing a reference picture list may need sharing between the VPUs and the DPB, and there is a time interval of at least ¼ frame between VPU0 and VPU1 due to the MV range as shown in FIG. 4.

If the time interval between VPU0 and VPU1 is greater than a ½ frame, overall decoding time may increase.

A time interval between VPUs is required to range from a ¼ to ½ frame, while decoding times of F(i) and F(j) are not always uniform, and thus synchronization may be needed not only at start of decoding but also during decoding.

Meanwhile, if F(j) is a non-reference frame, F(i) may not need to wait decoding by a determined sub-frame of F(j).

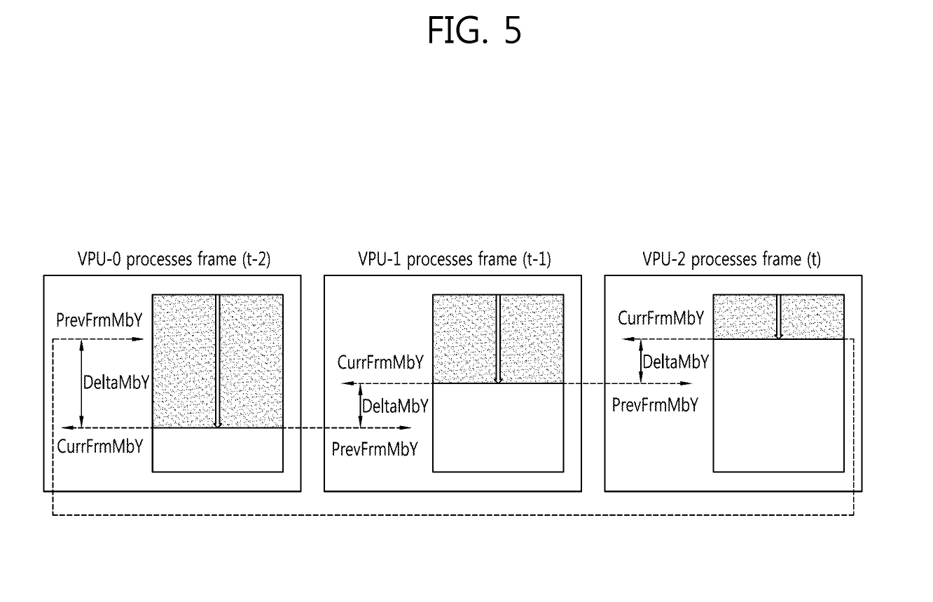

FIG. 5 illustrates an MbY synchronizing method according to an exemplary embodiment.

Referring to FIG. 5, regarding each start point of an MB row, if “PrevFrmMbY−CurrFrmMbY+MbHeight<DeltaMbY,” the controller may stand by without sending an MB_RUN command.

Here, PrevFrmMbY is a previous frame macroblock Y, and CurrFrmMbY is a current frame maroblock Y. MbHeight is a height of a macroblock, PrevMbY is a previous macroblock Y, and CurrMbY is a current macroblock Y.

PrevFrmMbY and CurrFrmMbY may be defined by Equation 1.

PrevFrmMbY=PrevFrmNum*MbHeight+PrevMbY

CurrFrmMbY=CurrFrmNum*MbHeight+CurrMbY [Equation 1]

Meanwhile, DeltaMbY may be signaled from a host through “CMD_DEC_SET_FRAME_BUF_MULTI_VPU.”

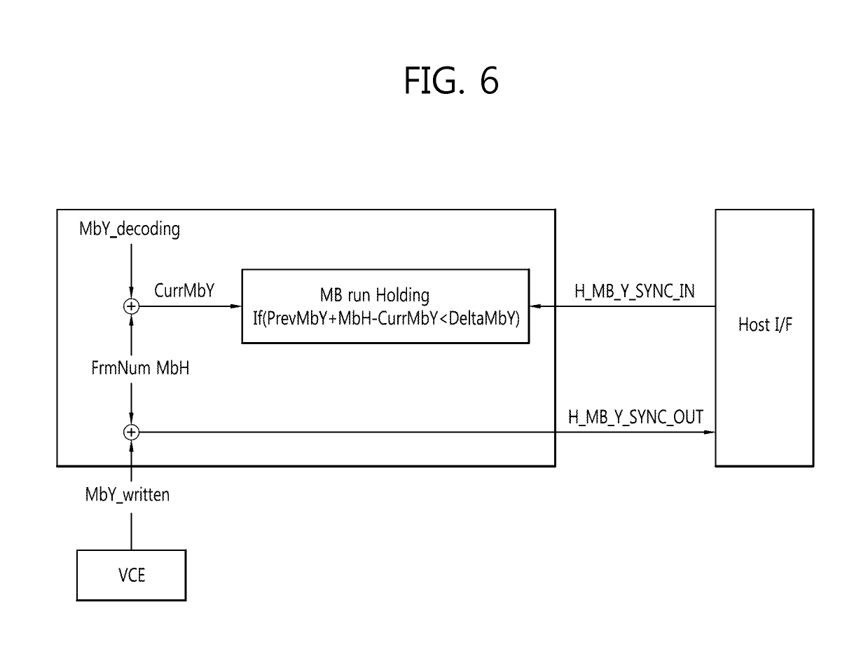

FIG. 6 illustrates that the controller performs synchronization according to information signaled from the host according to an exemplary embodiment.

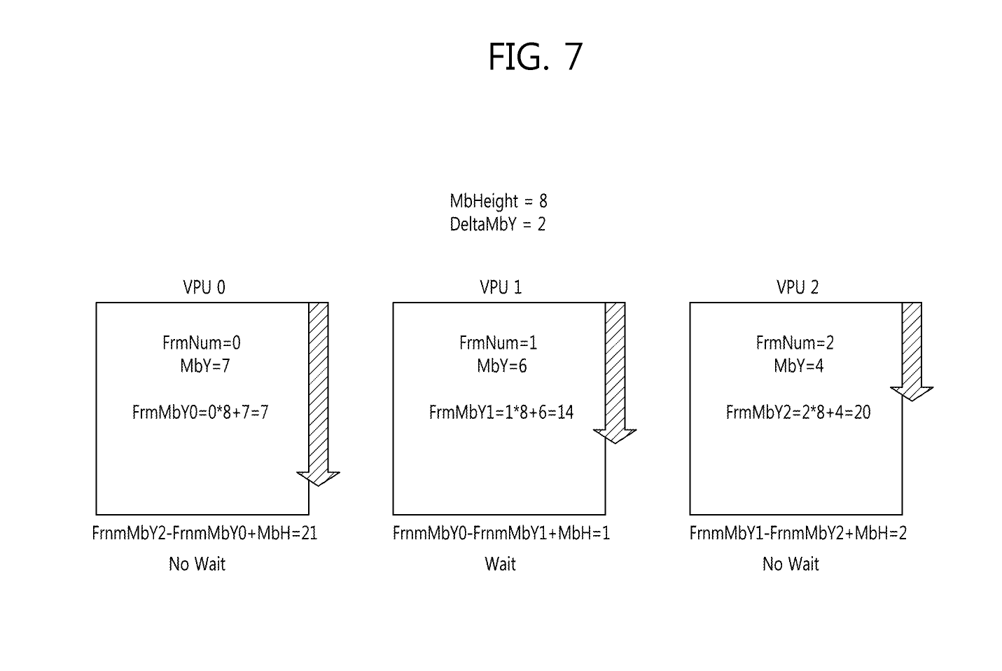

FIG. 7 illustrates the MbY synchronizing method in detail, in which DeItaMBY=2, MbHeight=8.

Referring to FIG. 7, FrmMbY may be calculated by Equation 2, where “0<=PrevFrmMbY−CurrFrmMbY+MbHeight<=vpu_num*MbHeight.” Here, vpu_num represents a VPU number.

FrmMbY=FrmNum*MbHeight+MbY [Equation 2]

Further, if M satisfies “vpu_num*MbHeight<M=2̂m<=2̂16=N,” “PrevFrmMbY−CurrFrmMbY+MbHeight” may be calculated by Equation 3.

$$PrevFrmMbY - CurrFrmMbY + MbHeight = ( PrevFrmMbY - CurrFrmMbY + MbHeight ) \% M = ( ( ( PrevFrmMbY \% M ) - CurrFrmMbY ) \% M + MbHeight ) \% M = ( ( ( PrevFrmMbY \% N ) - CurrFrmMbY ) \% N + MbHeight ) \% M \qquad [ Equation 3 ]$$

Accordingly, when the controller does +/−operations with respect to a 16-bit variable and finally multiplies the variable and “M−1,” an error by a wraparound may not occur.

For instance, if vpu_num=4 and MbHeight=2304/16=144, M=1024 and m=10 bits.

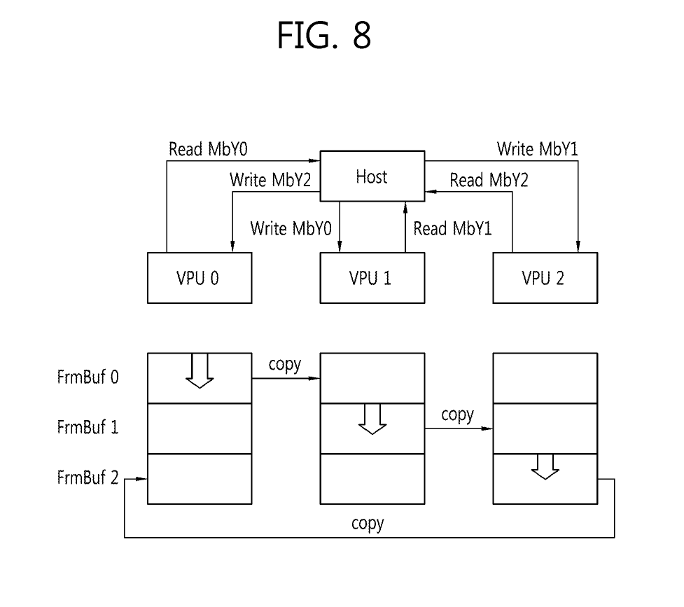

FIG. 8 illustrates a method of processing a video when the VPUs are unable to share the DPB according to an exemplary embodiment.

Referring to FIG. 8, when the VPUs are unable to share the DPB, the host may need to copy a frame buffer.

Here, operations of each VPU may be carried out in the following order.

1. Host gives pic_run command to VPU0

2. Host reads H_MBY_SYNC_IN from VPU2 (polling or interrupt)

(Here, interrupt used for low_delay_coding is used)

3. Host copies frame buffer from VPU2 to VPU0

4. Host writes MbY to H_MBY_SYNC_OUT of VPU0 (MbY polling or interrupt)

Here, H_MBY_SYNC_IN is MbY position that the previous VPU writes, and H_MBY_SYNC_OUT is a MbY position that the current VPU writes.

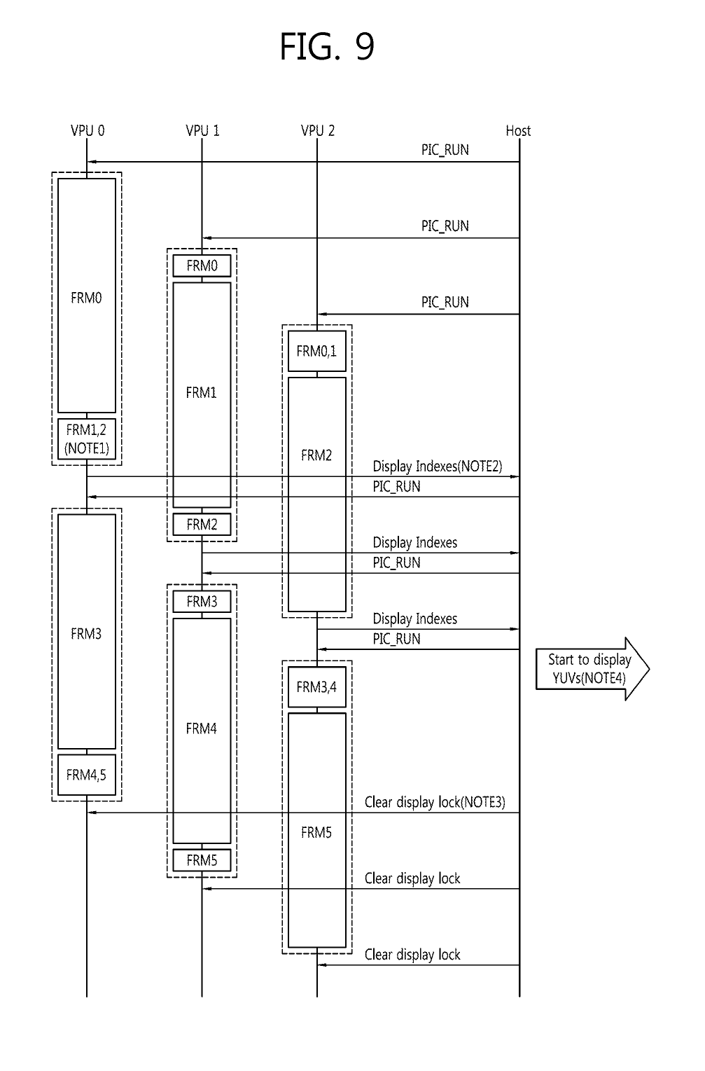

FIG. 9 illustrates a DPB synchronizing method according to an exemplary embodiment.

Referring to FIG. 9, when “(frame number % CMD_DEC_SEQ_MULTI_VPU_NUM) !=CMD_DEC_SEQ_MULTI_VPU_ID,” is only DPB manipulation, such as ref_pic_marking and allocation of a current YUV, may be carried out, skipping decoding macroblock data and a slice header except for a first slice.

For example, VPU0 may decode only an SPS, a PPS and a first slice header of FRM 1 and 2, without decoding macroblock data on FRM 1 and 2.

All VPUs report the same display indexes, wherein a number of the indexes may be maximally a number of the VPUs.

Display lock for all VPUs may be lifted to synchronize the DBPs, and display of YUY may start after a last VPU finishes decoding.

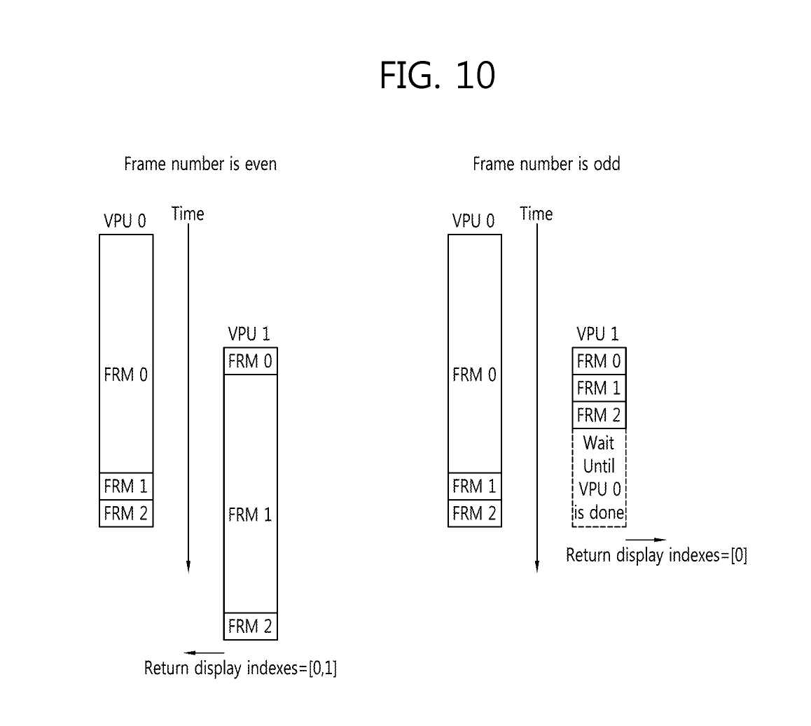

FIG. 10 illustrates a method of processing a stream end of a video stream according to an exemplary embodiment.

Referring to FIG. 10, to prevent returning a frame that VPU0 has not yet finish decoding from VPU1 to a display index as VPU1 is done before VPU0 at the stream end, a FW code may be added as follows.

Wait at PicEnd( ) if all the following conditions are met

1. vpu_id>0

2. the last picture in pic_run( )

3. PrevMbY<CurrMbY.

For frame-based parallel processing described above, an interface with the host may be changed.

For instance, H_MBY_SYNC_IN may be set as in Table 4.

TABLE 4

| Bits | Name | Description |
|---|---|---|
| 9:0 | MbYSyncIn | MbY position that the previous VPU writes |

H_MBY_SYNC_OUT may be set as in Table 5.

TABLE 5

| Bits | Name | Description |
|---|---|---|
| 9:0 | MbYSyncOut | MbY position that the current VPU writes |

CMD_DEC_SEQ_MULTI_VPU may be set as in Table 6.

TABLE 6

| Bits | Name | Description |
|---|---|---|
| 9:8 | type | Parallel processing type(0: not used, |
| | | 1: frame wave, 2: half frame) |
| 7:4 | vpu_num_minus_1 | Number of VPUs minus 1 |
| | | that are used for parallel processing |
| 3:0 | vpu_id | ID allocated for each VPU counted from 0 |

CMD_DEC_SET_FRAME_BUF_MULTI_VPU may be set as in Table 7.

TABLE 7

| Bits | Name | Description |
|---|---|---|
| 7:0 | delta_mby | Delta mbY between VPUs to be used for |
| | | synchronization |

Meanwhile, a value of RET_DEC_SEQ_FRAME_NEED may be changed to “max_dec_frame_buffering+NUM_VPU for current+NUM_VPU for display delay.”

Output multiple indexes of RET_DEC_PIC_IDX and RET_DEC_PIC_CUR_IDX may be set as in Table 8.

TABLE 8

| Bit position | Name |
|---|---|
| 7:0 | index 0 |
| 15:8 | index 1 |
| 23:16 | index 2 |
| 31:24 | index 3 |

As seen in Table 9, index −1 may indicate a stream end, and index 1 may indicate that there is no index to display.

TABLE 9

| index 0 | index 1 | index 2 | index 3 |
|---|---|---|---|
| 0 | 1 | −2 | −1 |

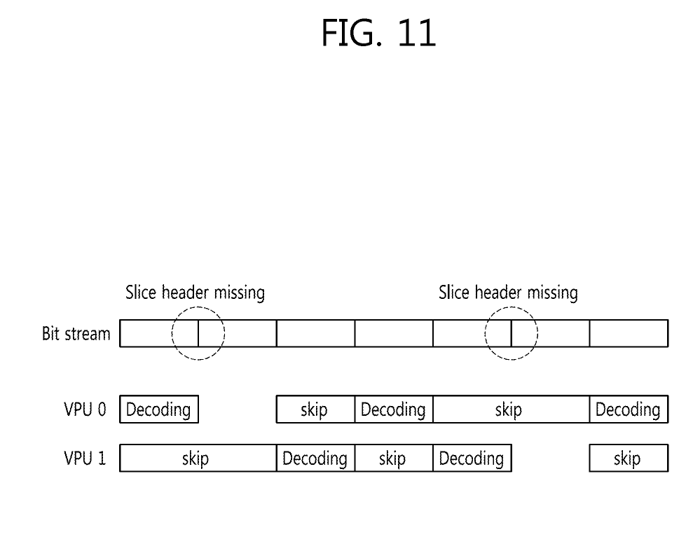

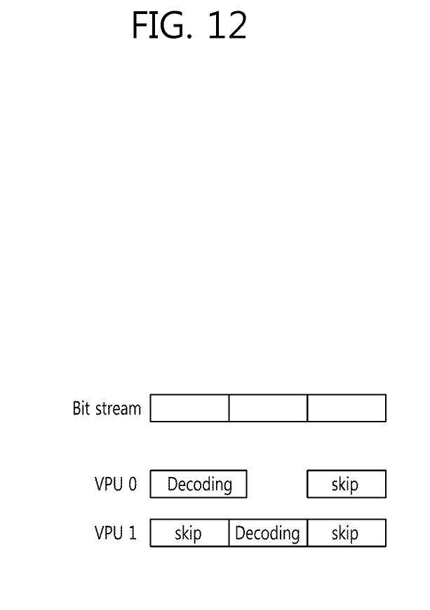

FIGS. 11 and 12 illustrate occurrence of errors in frame-based parallel processing.

Referring to FIG. 11, each VPU searches undecoded frame boundary, two or more VPUs may not decode the same frame.

Referring to FIG. 12, CheckVclNal( ) detects decoding a frame beyond an access unit (AU) boundary (slice with MbAddr=0) and finishs decoding. So decoding a frame beyond an access unit (AU) boundary is not occurs. Here, MbAddr is a macroblock address.

Here, a received bitstream may be encoded in accordance with H.264/AVC or H.265/HEVC. That is, parallel processing of frames using a multi V-Core according to the embodiment of the present invention may be applied to various standards, such as H.264/AVC and H.265/HEVC.

Although operations of the encoding apparatus and the decoding apparatus in accordance with H.264/AVC have been illustrated above, the present invention is not limited thereto.

For example, the video processing apparatus and method according to the present invention may be applicable to an encoding apparatus and a decoding apparatus configured in accordance with various video codec standards, such as HEVC.

In HEVC, a picture may include a plurality of slices, and a slice may include a plurality of largest coding units (LCUs).

Each LCU may be partitioned into a plurality of CUs, and an encoding apparatus may add information (flag) about partition to a bitstream. A decoding apparatus may recognize an LCU position using an address (LcuAddr).

A CU, which is not allowed to be partitioned, is considered as a prediction unit (PU), and the decoding apparatus may recognize a PU position using a PU index.

A PU may be divided into a plurality of partitions. Further, a PU may include a plurality of transform units (TUs).

In this case, video data may be transmitted to a subtraction module by a block unit with a predetermined size, for example, a PU or TU, based on an encoding mode.

A coding tree unit (CTU) is used as a unit for video encoding and defined as various square shapes. A CTU is referred to as a CU.

A CU has a shape of quadtree, and a 64×64 LCU with a depth of 0 is recursively partitioned to a depth of 3, that is, 8×8 CUs, thereby carrying out encoding based on an optimal PU.

A unit for performing prediction is defined as a PU, and each CU is partitioned into a plurality of blocks for prediction, in which prediction is performed separately for square blocks and rectangular blocks.

Here, if a video codec standard has no constraint on a vertical MV range described above, frame-based parallel processing may be performed based on a vertical MV range actually restricted in the encoding apparatus or decoding apparatus.

To this end, in video processing in accordance with HEVC, frame-based parallel processing of the present embodiment performs decoding in CTU raster order, instead of CTU tile order.

Further, to perform decoding in CTU raster order, CABAC context switching, bitstream switching, and slice header switching are needed on a column tile boundary.

That is, probability information on application of CABAC to a previous tile, video data to be decoded and a slice header are backed up and stored in a memory beyond a boundary of a tile in decoding in CTU raster order, and is read from the memory when the tile is decoded.

Burden of CABAC context switching is about “150 context*1 byte/context*2(load/save)=0.3 KB,” burden of bitstream switching is about “1 KB*1(load)=1 KB,” and burden of slice header switching may be about “0.3K*1(load)=0.3 KB.”

The aforementioned methods according to the present invention can be written as computer programs to be implemented in a computer and be recorded in a computer readable recording medium. Examples of the computer readable recording medium include read-only memory (ROM), random-access memory (RAM), CD-ROMs, magnetic tapes, floppy disks, optical data storage devices, and carrier waves, such as data transmission through the Internet.

The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While exemplary embodiments of the present invention have been shown and described, the present invention is not limited to the described exemplary embodiments. Instead, it would be appreciated by those skilled in the art that various changes and modifications may be made to these exemplary embodiments without departing from the spirit and scope of the invention as defined by the appended claims, and these changes and modifications are not construed as being separated from the technical idea and prospects of the present invention.

1. A video decoding apparatus comprising:
a controller to parse a parameter set from an input bitstream; and
a plurality of video processing units to process video data by a frame unit in parallel based on the parsed parameter set according to control by the controller,
wherein the video processing units sequentially decode different frames at an interval determined based on a motion vector range in the parameter set.

2. The video decoding apparatus of claim 1, wherein the motion vector range is defined by level information comprised in a sequence parameter set (SPS).

3. The video decoding apparatus of claim 1, wherein after a time corresponding to the interval since a first video processing unit among the video processing units starts decoding a first frame, a second video processing unit starts decoding a second frame.

4. The video decoding apparatus of claim 3, wherein the first video processing unit starts decoding a third frame after finishing decoding the first frame, and decoding sections of the first and third frames partly or wholly overlap part or whole of a decoding section of the second frame of the second video processing unit.

5. The video decoding apparatus of claim 1, wherein the video processing units are synchronized with a decoded picture buffer (DPB) to transmit and receive information necessary for managing a reference frame.

6. The video decoding apparatus of claim 1, wherein a position difference between macroblocks of a current frame and a reference frame is maintained larger than the motion vector range.

7. The video decoding apparatus of claim 1, wherein a boundary of a frame not decoded is retrieved so that two or more video processing units do not decode the same frame.

8. A video decoding method using a plurality of video processing units comprising:
parsing a parameter set from an input bitstream; and
processing video data by a frame unit in parallel based on the parsed parameter set using the plurality of video processing units,
wherein the processing in parallel starts sequentially decoding different frames at an interval based on a motion vector range in the parameter set.

9. The video decoding method of claim 8, wherein the motion vector range is defined by level information comprised in a sequence parameter set (SPS).

10. The video decoding method of claim 8, further comprising synchronizing the video processing units with a decoded picture buffer (DPB) to transmit and receive information necessary for managing a reference frame.

11. The video decoding method of claim 8, wherein a position difference between macroblocks of a current frame and a reference frame is maintained larger than the motion vector range.

12. The video decoding method of claim 8, wherein a boundary of a frame not decoded is retrieved so that two or more video processing units do not decode the same frame.

13. A video encoding apparatus comprising:
a controller to parse a parameter set from an input bitstream; and
a plurality of video processing units to process video data by a frame unit in parallel based on the parsed parameter set according to control by the controller,
wherein the video processing units sequentially decode different frames at an interval determined based on a motion vector range in the parameter set.

14. The video encoding apparatus of claim 13, wherein the motion vector range is defined by level information comprised in a sequence parameter set (SPS).

15. The video encoding apparatus of claim 13, wherein after a time corresponding to the interval since a first video processing unit among the video processing units starts decoding a first frame, a second video processing unit starts decoding a second frame.

16. The video encoding apparatus of claim 15, wherein the first video processing unit starts decoding a third frame after finishing decoding the first frame, and decoding sections of the first and third frames partly or wholly overlap part or whole of a decoding section of the second frame of the second video processing unit.

17. The video encoding apparatus of claim 13, wherein the video processing units are synchronized with a decoded picture buffer (DPB) to transmit and receive information necessary for managing a reference frame.

18. The video encoding apparatus of claim 13, wherein a position difference between macroblocks of a current frame and a reference frame is maintained larger than the motion vector range.

19. The video encoding apparatus of claim 13, wherein a boundary of a frame not decoded is retrieved so that two or more video processing units do not decode the same frame.
